(19) United States
(12) Patent Application Publication
(10) Pub. No.: US 2026/0339630 A1
(43) Pub. Date: Oct. 29, 2026

(54) INFORMATION PROCESSING DEVICE, INFORMATION PROCESSING METHOD, AND PROGRAM

(71) Applicant: Sony Interactive Entertainment Inc., Tokyo (JP)

(72) Inventors: Mitsuhiro Kubota, Saitama (JP); Nobuhisa Fujinami, Tokyo (JP); Yoshihiro Kimura, Saitama (JP)

(73) Assignee: Sony Interactive Entertainment Inc., Tokyo (JP)

(21) Appl. No.: 19/707,105

(22) Filed: Jun. 12, 2026

Related U.S. Application Data
(63) Continuation of application No. PCT/JP2024/042963, filed on Dec. 4, 2024.

(30) Foreign Application Priority Data
Dec. 14, 2023 (JP) 2023-211552

(51) Int. Cl. G06F 8/41; G06F 8/71

(52) U.S. Cl. CPC G06F 8/41; G06F 8/71

(57) ABSTRACT

An information processing device and a method for compiling source code written in a predetermined programming language and using a library having a plurality of versions are disclosed. When source code to be compiled is accepted and the source code accepted uses defined elements defined in the library, an example information processing device accepts a version specification specifying whether to use a defined element of any version among the plurality of versions, or allows coexistence of defined elements of the plurality of versions, and compiles the source code accepted, by treating each of the defined elements in the source code accepted as a defined element of any version among the plurality of versions according to the version specification.

### CROSS-REFERENCES TO RELATED APPLICATIONS

This application claims is a continuation of International Patent Application No. PCT/JP 2024/042963, filed Dec. 4, 2024, which claims the benefit and priority of JP Patent Application No. 2023-211552, filed Dec. 14, 2023, which are hereby incorporated by reference in their entirety.

### BACKGROUND

The present disclosure relates to an information processing device, an information processing method, and a program for compiling source code.

In order to execute source code written in a specific programming language on a computer, the source code needs to be compiled to generate an execution module that can be executed by the computer. Further, when the source code uses defined elements (classes, functions, variables, etc.) provided by a separate library (such as a standard library), object code of the library prepared in advance is linked to object code output by a compiler, thereby finally generating an execution module executable by the computer.

### SUMMARY

In the known technique described above, there may be a plurality of versions of the same library whose implementation methods differ from each other. A plurality of versions of a library having different implementation methods are expected to differ also in binary-level interface for using defined elements provided by the library. In that case, a plurality of versions of the library may coexist in code, such as when an attempt is made to change the version to be used midway through but, for some reason, the version cannot be changed at once in all parts of the source code. As a result, an execution module containing inconsistent content may be generated, resulting in problems such as the execution module being unable to be executed properly. Therefore, when a plurality of different versions exists for a library, it is desirable to be able to clearly specify which version among the plurality of versions is to be used for the defined elements of the library included in the source code, or to enable safe coexistence of the plurality of versions.

The present disclosure has been made in consideration of the above circumstances, and one of its objects is to provide an information processing device, an information processing method, and a program that enable effective use of a library for which a plurality of versions exist by specifying the version to be used or enabling safe coexistence of the plurality of versions when compiling source code that uses such a library for which a plurality of versions exist.

An information processing device according to an aspect of the present disclosure is an information processing device configured to compile source code written in a predetermined programming language and using a library having a plurality of versions, the information processing device including: a receiving unit configured, when source code to be compiled is accepted and the source code accepted uses defined elements defined in the library, to accept a version specification specifying whether (1) to use a defined element of any version among the plurality of versions, or (2) to allow coexistence of defined elements of the plurality of versions; and a compilation unit configured to compile the source code accepted, by treating each of the defined elements in the source code accepted as a defined element of any version among the plurality of versions according to the version specification.

An information processing device according to another aspect of the present disclosure is an information processing device configured to compile source code written in a predetermined programming language and using a library having a plurality of versions, the information processing device including: a receiving unit configured to accept source code that uses defined elements defined in the library as a target for compilation; and a compilation unit configured to perform compilation by treating each of the defined elements used in the source code accepted as a defined element of a predetermined default version among the plurality of versions when the version of the defined element is not explicitly specified, and, when the version is explicitly specified, by treating each of the defined elements used in the source code accepted as a defined element of the explicitly specified version.

An information processing method according to an aspect of the present disclosure is an information processing method for compiling source code written in a predetermined programming language and using a library having a plurality of versions, the information processing method including: when source code to be compiled is accepted and the source code accepted uses defined elements defined in the library, accepting a version specification specifying whether (1) to use a defined element of any version among the plurality of versions, or (2) to allow coexistence of defined elements of the plurality of versions; and compiling the source code accepted, by treating each of the defined elements in the source code accepted as a defined element of any version among the plurality of versions according to the version specification.

A program according to an aspect of the present disclosure causes an information processing device configured to compile source code written in a predetermined programming language and using a library having a plurality of versions to: when source code to be compiled is accepted and the source code accepted uses defined elements defined in the library, accept a version specification specifying whether (1) to use a defined element of any version among the plurality of versions, or (2) to allow coexistence of defined elements of the plurality of versions; and compile the source code accepted, by treating each of the defined elements in the source code accepted as a defined element of any version among the plurality of versions according to the version specification. This program may be stored and provided on a non-transitory computer-readable information storage medium.

### BRIEF DESCRIPTION OF THE DRAWINGS

FIG. 1 is a configuration block diagram showing a configuration of an information processing device according to an embodiment of the present disclosure.

FIG. 2 is a functional block diagram showing functions of the information processing device according to an embodiment of the present disclosure.

FIG. 3 is a diagram showing an example of a facade header.

FIG. 4 is a diagram showing an example of source code in a case where a user-defined element defined in one compilation target code file is used in another compilation target code file.

### DETAILED DESCRIPTION

Embodiments of the present disclosure will be described in detail below with reference to the drawings.

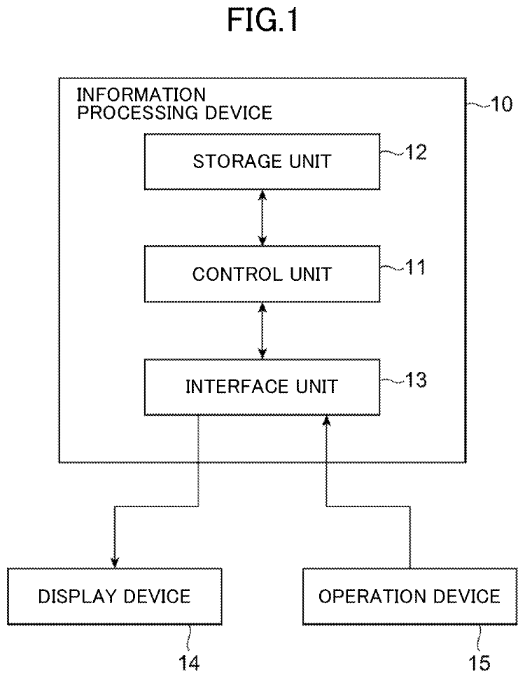

FIG. 1 is a configuration block diagram showing a configuration of an information processing device 10 according to an embodiment of the present disclosure. The information processing device 10 is a personal computer, a server computer, or the like, and is configured to include a control unit 11, a storage unit 12, and an interface unit 13. Further, the information processing device 10 is connected to a display device 14 and an operation device 15.

The control unit 11 includes at least one processor such as a CPU, and executes various types of information processing by executing programs stored in the storage unit 12. A specific example of the processing executed by the control unit 11 in the present embodiment will be described later.

The storage unit 12 includes at least one memory device such as a RAM, and stores a program to be executed by the control unit 11 and data to be processed by the program.

The interface unit 13 is an interface for data communication with the display device 14 and the operation device 15. The information processing device 10 is connected to each of the display device 14 and the operation device 15 either by wire or wirelessly via the interface unit 13.

The display device 14 displays, on a screen, an image corresponding to a video signal supplied from the information processing device 10 via the interface unit 13. The operation device 15 is, for example, a keyboard, a mouse, or the like, and accepts an operation input from a user. The information processing device 10 receives, from the operation device 15 via the interface unit 13, an operation signal indicating the content of an operation input that the operation device 15 has received from the user.

The information processing device 10 according to the present embodiment has a function of compiling source code written by a user in a predetermined programming language to generate an execution module executable by a computer. In the following, as a specific example, the information processing device 10 compiles source code written in C++ as the programming language.

In general, a single application program is generated based on a plurality of source code files generated as separate files. The information processing device 10 does not need to compile the plurality of source code files at once, and may individually compile each source code file as a compilation unit and output object code corresponding to that source code file. In the following, source code to be compiled in a single compilation process by the information processing device 10 will be referred to as compilation target code S.

Further, in the present embodiment, it is assumed that the compilation target code S uses a predetermined library. That is, the compilation target code S uses at least a part of defined elements defined in the library and made available outside the library. The defined element is an element defined in any location in source code created by a user and/or in a library and available in source code different from the source code defining the element, and may include a class, a function, a variable, and a type alias. Further, the defined element may also include various elements that can be defined in source code, such as an enumeration type, a union, a template, and a concept.

It is assumed that, in the following, the compilation target code S uses the C++ standard library (hereinafter, simply referred to as the standard library L). Further, in the present embodiment, it is assumed that the standard library L used by the compilation target code S has a plurality of versions having different implementation methods and, accordingly, different application binary interfaces (ABIs) for using defined elements provided by the library. Specifically, in the following description, it is assumed that there are two versions of the standard library L, i.e., version 1 and version 2, and the compilation target code S written by a user uses either one or both of the versions. The version 1 of the standard library L will be hereinafter referred to as the standard library L-v1, and the version 2 of the standard library L will be hereinafter referred to as the standard library L-v2.

To allow use of these versions of the standard library L, the storage unit 12 of the information processing device 10 stores in advance objects of the defined elements provided by the standard library L-v1 and objects of the defined elements provided by the standard library L-v2. As will be described later, these objects do not need to be provided separately for each version and may be provided in a single library archive. Further, it is assumed that, for at least some of the defined elements provided by the standard library L, header files that declare the defined elements are prepared for each of the plurality of versions. The defined elements defined in the standard library L are hereinafter referred to as standard defined elements.

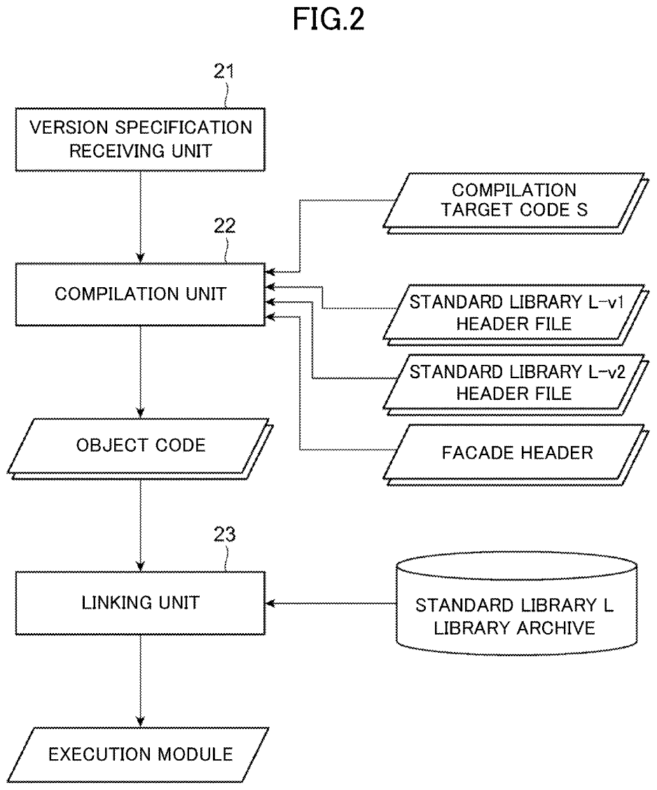

The following describes functions achieved by the information processing device 10, with reference to a functional block diagram of FIG. 2. As shown in FIG. 2, the information processing device 10 functionally includes a version specification receiving unit 21, a compilation unit 22, and a linking unit 23. These functions are achieved by the control unit 11 operating according to one or more programs stored in the storage unit 12. These programs may be provided to the information processing device 10 via a communication network such as the Internet, or on a computer-readable information storage medium such as an optical disk.

The version specification receiving unit 21 accepts, when a user compiles the compilation target code S, a specification of a version specifying which version of the defined elements is to be used among a plurality of versions (hereinafter referred to as a version specification) as the version of the standard defined elements used by the compilation target code S. Further, it is assumed that the version specification receiving unit 21 accepts, as version specifications, a specification to use a standard defined element of the standard library L-v1, a specification to use a standard defined element of the standard library L-v2, as well as a specification that allows the coexistence of standard defined elements of a plurality of versions. The version specifications are referred to when the compilation unit 22, which will be described later, compiles the compilation target code S.

As a specific example, it is assumed that the version specification receiving unit 21 accepts a version specification by referring to an option argument specified by a user in a command line when executing a compiler program. For example, a user specifies the version by setting any of the following four values for the option argument “-lver-stdlib.”
lver-stdlib=v1
lver-stdlib=v2
lver-stdlib=v1+v2
lver-stdlib=v2+v1

Here, the first and second values are specifications to use specific versions of standard defined elements, where v1 specifies use of version 1 and v2 specifies use of version 2. Further, the third and fourth values are specifications that allow coexistence of two versions, and the order in which the version numbers are written specifies the version of the standard defined element used by default. That is, v1+v2 specifies version 1 as the default version, and v2+v1 specifies version 2 as the default version. Using this notation, a user can specify a default version alongside a version specification that allows coexistence of multiple versions.

The compilation unit 22 compiles the compilation target code S based on a user command and outputs object code based on the content of the code S. Further, the compilation unit 22 executes, as necessary, pre-processing such as expanding macro calls in the compilation target code S prior to the compilation process.

Here, the compilation unit 22 executes compilation based on the version specification accepted by the version specification receiving unit 21 so that the compilation target code S uses the standard library L of the specified version. A specific method for using the standard library L of the specified version will be described later.

The linking unit 23 links one or more object code files output by the compilation unit 22 with the object code of the standard library L to generate an execution module executable by a computer. At this time, the linking unit 23 links either the object code of the standard library L-v1 or the object code of the standard library L-v2 for each of the standard defined elements used within the compilation target code S based on the compilation results. Thus, an execution module of an application program executable by the computer is generated.

Hereinafter, a specific example of a method for making a plurality of versions of the standard library L available to the compilation target code S will be described.

The standard defined element of the standard library L used in the compilation target code S is described by a name of the std namespace starting with “std::”. The compilation unit 22 switches the namespace of the standard defined element to another namespace based on the version specification accepted by the version specification receiving unit 21. Accordingly, the compilation unit 22 can determine which of the standard defined elements defined individually in a plurality of versions of the standard library L to use. The namespace switching is achieved using a process similar to that used for a case where an inline namespace is declared. That is, the compilation unit 22 can execute compilation using the user-specified version of the standard defined element by switching the name of the standard defined element to the name of another namespace as if an inline namespace were declared in the compilation target code S despite the absence of such declaration.

Instead of switching the namespace for both the standard library L-v1 and the standard library L-v2, the compilation unit 22 may switch the namespace only when one of them is used. For example, it is assumed that a standard defined element of the standard library L-v1 is declared using the std namespace, and a standard defined element of the standard library L-v2 is declared using the “std::__v2” namespace. In this case, the compilation unit 22 does not need to switch the namespace of the standard defined element when the version using the standard library L-v1 is specified. On the other hand, when the version using the standard library L-v2 is specified, the standard defined element of the standard library L-v1 is made invisible from the std namespace, and the standard defined element of the standard library L-v2 is made visible as if the std:: __v2 namespace were declared as an inline namespace in the std namespace, thereby switching the version of the standard defined element to be used. Thus, performing namespace switching only when the standard library L-v2 is used enables compilation using the user-specified version of the standard defined element.

By selecting the version of the standard library L through namespace switching as described above, symbols of the standard defined elements can be kept from overlapping between a plurality of versions of the standard library L. Thus, the object code itself of the standard library L can be combined into a single library archive because different versions of the same standard defined element are managed under different symbol names in the archive. In this way, when the linking unit 23 performs linking, the linking can be performed using a single library archive as the link target regardless of which version of the standard library L is used.

When the version specification receiving unit 21 accepts a version specification that allows coexistence of a plurality of versions, one of the plurality of versions is defined as a default version (that is, the version to be preferentially used). Here, as described above, the version specification receiving unit 21 accepts, from the user for each compilation, a specification of the default version together with the version specification that allows coexistence of a plurality of versions. However, the present embodiment is not limited to this, and the compilation unit 22 may use, as the default version, a specific version defined in advance elsewhere. By doing so, even if the version specification receiving unit 21 does not receive a default version specification from a user simultaneously with a version specification that allows coexistence of a plurality of versions during compilation, the compilation unit 22 can execute the compilation process involving coexistence of a plurality of versions.

Unless otherwise described in the compilation target code S, the compilation unit 22 executes compilation using the standard defined element of the default version when a version specification that allows coexistence of a plurality of versions is provided. This processing may be similar to the aforementioned processing used when a version specification using a specific version is accepted.

On the other hand, when a predetermined description is present in the compilation target code S, the compilation unit 22 executes compilation by treating the standard defined element used at the location specified by the description as being a defined element of the version specified by the description. This allows a plurality of versions of the same standard defined element to coexist within a single compilation target code S file.

In the case of C++, a pragma can be used within this compilation target code S to specify the version of the standard library L. For example, when a user wishes to locally use a standard defined element of the standard library L-v2, the user writes the following pragma in the compilation target code S.
#pragma LVER std_visibility push(v2)

Here, LVER is an example of a keyword for using this function, and v2 is a version specification. Further, when a user wishes to use a standard defined element of the standard library L-v1, the user writes the following pragma.
#pragma LVER std_visibility push(v1)

Based on these pragmas, the compilation unit 22 switches a mode that determines the version of the standard defined elements to the specified mode. That is, when such a pragma is accepted, the compilation unit 22 temporarily stores the current mode, and compiles the standard defined elements at subsequent locations as those of the version specified by the pragma.

To end such a mode switch and return to the original mode, the user writes the following pragma in the compilation target code S.
#pragma LVER Std_visibility pop

Based on this pragma, the compilation unit 22 resets the temporary version specification specified by the aforementioned pragma, and executes the compilation process in the original mode before switching for subsequent portions. This allows an author of the compilation target code S to locally use a standard defined element of any version specified by the author at a specific location in the compilation target code S.

It is considered that, when a separate file is included in the compilation target code S, processing code within the included file according to the mode switched by the pragma may cause inconvenience. This is because the file to be included is assumed to be written on the premise that a standard defined element of a specific version is used. Accordingly, when another file is included from the compilation target code S, the compilation unit 22 may perform mode switching on the assumption that a pragma specifying switching to a specific mode is implicitly set for the entire file to be included. That is, when another file is included, the compilation unit 22 performs control to switch to the mode that uses the specific version when compiling the content of the included file, and resets the mode to the original mode upon completion of processing of the included file. In this way, for each included file, the standard defined elements in the file can be compiled as those of an appropriate version. The mode in which a file to be included is processed may be determined according to attribute information of that file, such as the location of the file or the file name. Further, the compilation unit 22 may compile a specific file to be included, in a mode that uses a predetermined version.

Further, in the above description, the version of the standard defined element is determined based on the specification by the pragma written at the location in the compilation target code S where the standard defined element is actually used. However, if a macro is used in the compilation target code S, determining the version of the standard defined element according to the specification in the source code at the expansion site where the macro is expanded may cause inconsistencies with the version of the standard defined element intended by the macro. To address this, if a macro is used, the version of the standard defined element at the expansion site where the macro is expanded is determined based on the specification of the version of the standard library L written at the location where the macro is defined.

However, for a standard defined element included in an actual argument passed to the macro, the version of the standard defined element should be determined based on the version specified at the location where the actual argument is written.

Therefore, when macro expansion is performed, the compilation unit 22 temporarily stores, in a predetermined storage area, the version of the standard library L specified at the location where the macro before expansion is defined, and the version of the standard library L specified at the location where the actual argument passed to the macro is written. Then, after the macro expansion, the version of each standard defined element included in the code after the macro expansion is determined based on the temporarily stored information about the version specified at the location where the macro is defined and the version specified at the location where the actual argument is written. After that, compilation is performed using the standard defined element of the determined version by switching the aforementioned namespaces. Thus, the compilation target code S in which a plurality of versions of the standard library L coexist can be appropriately compiled even when a macro is used.

The handling of a header file will be described here. In the present embodiment, it is assumed that header files declaring predetermined standard defined elements defined by the standard library L are prepared for each version of the standard library L. When any version of the standard defined element is used in a single compilation target code S file, it is necessary to select and include a header file corresponding to that version at the time of compilation. Further, when a plurality of versions are used, a plurality of header files corresponding to the plurality of versions need to be included at the time of compilation. If such selective use of include directives must be written in the compilation target code S, it becomes a burden on the user who writes the source code. In view of this, in the present embodiment, apart from the header files for the plurality of versions, a representative header having the same name and representing both (hereinafter referred to as a facade header) is prepared, and the compilation unit 22 preferentially includes the facade header when the facade header exists. Based on the description in the facade header, header files of the versions required for compilation are selectively included, so that headers containing declarations required for compilation can be included without changing the description of the include directives in the compilation target code S from the existing one. Further, compared with a case where all headers of the plurality of versions are unconditionally included, inclusion of unnecessary headers can be avoided, and an increase in the time required for the compilation process can be suppressed.

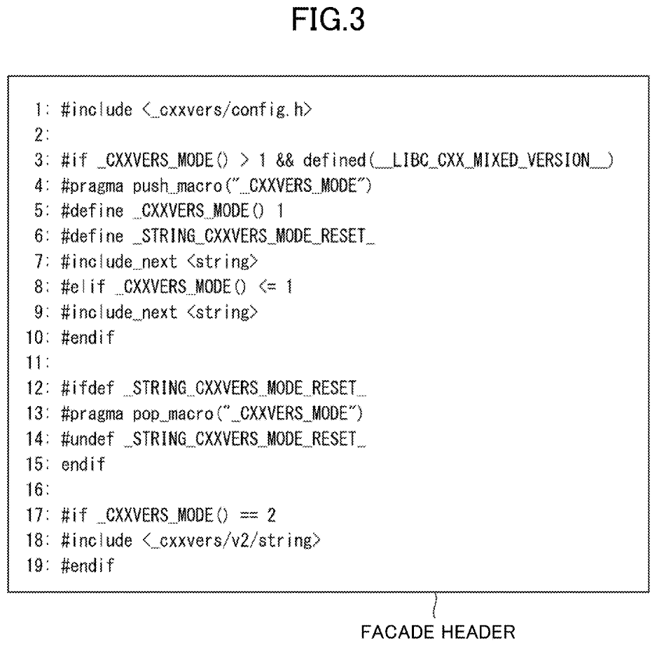

FIG. 3 shows an example of a facade header. The line number shown at the top of each line in the figure is given for explanatory purposes and is not actually required. The following describes, as an example, a case of including a declaration of the “std:: string” type (hereinafter simply referred to as the string type) for handling character strings in the standard library L. Further, in this example, it is assumed that the header declaring the string type for the standard library L-v1 is located in “include/string,” that the header declaring the string type for the standard library L-v2 is located in “include/_cxxvers/v2/string,” and that the facade header shown in FIG. 3 is located in “include/_cxxvers/facade/string.” Further, it is assumed that the compilation unit 22 is configured to search, as include paths, “include/_cxxvers/facade/” where the facade header is stored, “include/” where the header for the standard library L-v1 is stored, and “include/_cxxvers/v2/” where the header for the standard library L-v2 is stored, in this order. Therefore, when the compilation target code S contains a directive to include <string>, the compilation unit 22 preferentially selects the facade header as the inclusion target if the facade header is located in “include/_cxxvers/facade/.”

The “_CXXVERS_MODE( )” referenced on line 3 of the facade header is a macro that returns the value of the current macro replacement version. This macro replacement version is used to expand the macro used in the header of the standard library L for inclusion from the facade header so that the standard defined element is declared within the namespace according to the specified version. In this example, it is assumed that control for expanding the macro according to the specified version is achieved by the content written in “<_cxxvers/config.h>” which is included on line 1. Further, the initial value of the macro replacement version is set to 2, and is set to 1 when use of version 1 of the standard defined element is specified by version specification. Further, “__LIBC_CXX_MIXED_VERSION__” is a macro defined by the compilation unit 22 and is set when a version that allows coexistence of a plurality of versions is specified.

If the macro replacement version value is 2, and a mode allowing coexistence of a plurality of versions is specified, the current macro replacement version is temporarily saved and then the macro replacement version value is set to 1 (lines 3 to 5), after which the <string> header is included (line 7). In this case, since paths subsequence to the path where the current facade header is located are searched as the include paths, the header of the standard library L-v1 is included. Further, since the value of the macro replacement version is set to 1 here, the macros related to the standard library L in the included header will be expanded so that the standard defined element is declared in the namespace corresponding to version 1. After that, the value of the macro replacement version is reset and returns to the value (2 in this case) temporarily saved on line 4 (lines 12 to 15).

On the other hand, if the value of the macro replacement version is equal to or less than 1, the header of the standard library L-v1 is included as it is (lines 8 and 9). Since the value of the macro replacement version is assumed to be 1 here, the macros in the included header are expanded to correspond to version 1, as in the case of inclusion in the aforementioned line 7. Note that, since the value of the macro replacement version is not changed in this case, it is not necessary to reset the value of the macro replacement version, unlike the above-described case.

Further, if the value of the macro replacement version is 2, the header of the string type defined in the standard library L-v2 is included (lines 17 to 19). Since the header of the standard library L-v2 is stored in another directory here, the include target is specified by a relative path (line 18). At this time, since the value of the macro replacement version is set to 2, the macros in the included header will be expanded so that the standard defined element is declared in the namespace corresponding to version 2.

The compilation unit 22 can include the header file of the necessary version of the standard defined element by including the facade header. Specifically, the compilation unit 22 includes the header file of the standard library L-v1 by setting the value of the macro replacement version to 1 when the use of the standard library L-v1 is specified. When the use of the standard library L-v2 is specified, the header file of the standard library L-v2 is included because the value of the macro replacement version is set to the initial value of 2. Further, when coexistence of a plurality of versions is specified, the header files of two versions are both included by setting the “__LIBC_CXX_MIXED_VERSION__” macro. As a result, in the compilation target code S, the necessary headers can be included simply by including the facade header, without specifying the headers for each version.

Further, when the headers of the standard library L-v1 or L-v2 are included from the facade header, the compilation unit 22 switches the value of the macro replacement version to the corresponding value before performing the inclusion. This allows the macros used within the header for inclusion to be expanded into content corresponding to the specified version.

Note that the above description deals with an example of the facade header in which headers of the same name exist for both the standard libraries L-v1 and L-v2. For a standard defined element for which only one of the headers exists, the header of the corresponding version may be included according to the priority order of the include paths, without using the facade header. However, if use of a macro is required for declaring the standard defined element in the namespace of the corresponding version, the facade header may be placed, and the value of the macro replacement version may be switched therein, and then, the header of the corresponding version may be included. For example, if only the header for the standard library L-v1 exists, and a macro used therein needs to be expanded in the corresponding version, a facade header that includes control for switching the value of the macro replacement version is created and placed, similarly to the example shown in FIG. 3. In this case, however, the header for the standard library L-v2 does not need to be included; therefore, the description from line 17 onward in the example in FIG. 3 is not necessary.

Further, if headers of the same name exist in both the standard library L-v1 and the standard library L-v2, and definitions for both headers are needed, a facade header that includes both is created. For example, by preparing a facade header in which “&& defined(__LIBC_CXX_MIXED_VERSION__)” is removed from line 3 of the facade header shown in FIG. 3, both the header of the standard library L-v1 and the header of the standard library L-v2 can be included when the value of the macro replacement version is 2 (initial value).

Further, when recursively including another header from within a header, necessary headers can be appropriately included by using a facade header as shown in FIG. 3.

As a specific example, when a header that declares a defined element of the standard library L-v1 attempts to include another header that declares a different defined element of the standard library L-v1 (here, a header that declares the string type), providing a facade header corresponding to this string type header allows the compilation unit 22 to include this facade header with the value of the macro replacement version set to 1. Then, the string type header of the standard library L-v1 is included from this facade header (line 9). Here, since the “_STRING_CXXVERS_MODE_RESET_” macro on line 6 is not set, the processing on line 13 is skipped, the value of the macro replacement version is maintained at 1, and the value is reset after returning to the original header. Note that, since the standard library L-v2 is assumed to be a newer version than the standard library L-v1, inclusion of the header of the standard library L-v2 from the header of the standard library L-v1 is not contemplated.

On the other hand, when the header for the string type is included from a header that declares a defined element of the standard library L-v2, as well, if a facade header is prepared, the compilation unit 22 first includes this facade header. At this time, the value of the macro replacement version is set to 2. Thus, through the control described above, the compilation unit 22 includes the string type header of the standard library L-v2 and, if coexistence of a plurality of versions is specified, also includes the string type header of the standard library L-v1. In this way, even when a header of a standard defined element is included from another header, inclusion via the facade header allows the header of the required version to be included with the value of the corresponding macro replacement version set.

According to the processing described above, when only one compilation target code S file is compiled, the user can selectively use a plurality of versions of the standard library L used in that compilation target code S, or cause them to coexist. However, when a plurality of compilation target code S files are compiled individually and then linked to generate an execution module, there is a risk that a version inconsistency of the standard library L occurs among the plurality of compilation target code S files. A control for preventing such inconsistency will be described below.

Specifically, an example where a defined element that is defined in any of a plurality of source code files and used from another source code file uses the standard library L will be described. A defined element defined in source code created by a user as described above is hereinafter referred to as a user-defined element. Further, for convenience of explanation, the source code that defines a user-defined element available from another source code file is referred to as compilation target code S1, and the source code that uses the user-defined element defined in compilation target code S1 is referred to as compilation target code S2. The compilation target code S1 may be, for example, a library created by the user, which is source code containing user-defined elements such as a class and a function that are commonly used from a plurality of source code files.

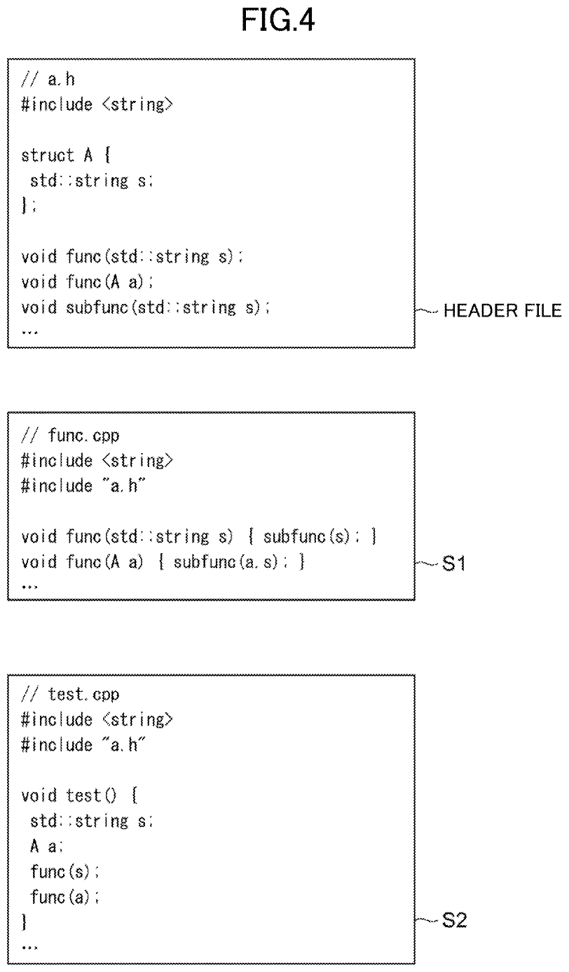

FIG. 4 shows specific examples of such source code files. In the example of the figure, there are three source code files: a header file a.h containing a declaration of a structure A and a function func; func.cpp, which is the compilation target code S1 containing a definition of the function func; and test.cpp, which is the compilation target code S2 that uses the function func. Both func.cpp and test.cpp include a.h.

Here, it is assumed that the compilation target code S1 and the compilation target code S2 are compiled in modes using different versions of the standard library L by using the version specification method described above. Then, even when the compilation of the respective compilation target code S files is successful, the object code files generated by the compilation refer to different versions of the string class. Therefore, if an execution module generated by linking the object code files as they are is executed, an inconsistency occurs when executing the function func.

Specifically, when the compilation target code S1 is compiled, object code for two functions, “func(std::string s)” and “func(A a),” is generated, and symbols representing the respective start addresses are generated. When the compilation target code S1 is compiled in a mode using the standard library L-v1, the symbols for the two functions are “func(std::basic_string<. . . >)” and “func(A).” Here, the part “basic_string<. . . >” represents the actual type of the class referred to by the alias “std:: string” in the standard library L-v1. Further, here, the defined element of the standard library L-v1 is expressed by the name of the std namespace. On the other hand, when the compilation target code S1 is compiled in a mode using the standard library L-v2, the symbols for the two functions are generated as “func(std::__v2::basic_string<. . . >)” and “func(A).” In this example, “std:: string” has been converted to the name of the “std:: __v2” namespace. Further, the part “basic_string<. . . >” in this example represents the actual type of “std::string” defined in the standard library L-v2.

Further, when the compilation target code S2 is compiled, object code that calls the two functions, “func(std:: string s)” and “func(A a),” is generated. The object code generated here will be code that performs a call using the same symbols as those used when the compilation target code S1 is compiled, depending on which standard library L is used as the mode for compiling the compilation target code S2. In other words, when compilation target code S2 is compiled in a mode using the standard library L-v2, the function call func(s) attempts to call the function defined in the compilation target code S1 using the symbol “func(std::__v2::basic_string<. . . >),” and the function call “func(a)” attempts to call the function defined in the compilation target code S1 using the symbol “func(A).”

For example, it is assumed that the compilation target code S1 is compiled in a mode using the standard library L-v1, and the compilation target code S2 is compiled in a mode using the standard library L-v2. Then, for the function “func(std::string s),” the symbol generated when the compilation target code S1 is compiled and the symbol generated when the compilation target code S2 is compiled include types of different string classes, and therefore the symbols do not match. Therefore, the linking unit 23 cannot link these object code files, leading to an error. On the other hand, as for the function “func(A a),” since both symbols are “func(A)” and match, it is assumed that the linking unit 23 does not cause an error as it is. However, the structure A includes a member s of a string type in the standard library L, and the member s is used in the function “func(A a).” Therefore, if the compilation target code S1 defining a user-defined element that utilizes the standard defined element of the standard library L and the compilation target code S2 using the user-defined element are compiled using different versions of the standard library L, there is a risk that an inconsistency may occur due to mismatch in the versions of the standard library L.

In view of this, in the present embodiment, the compilation unit 22 associates, with each user-defined element in the compilation target code S, a value (identification value) for identifying the user-defined element, and the linking unit 23 refers to the identification value, whereby such inconsistency is detected. Such control can be achieved by utilizing the function of an absolute symbol conventionally provided by a C++ linker program.

Specifically, the compilation unit 22, when compiling the compilation target code S, determines an absolute symbol value to be used as an identification value for each user-defined element in the compilation target code S, and outputs object code in which the determined value is included in association with the corresponding user-defined element. At this time, when the same version of the standard library L is specified to be used for a plurality of compilation target code S files, the compilation unit 22 determines the absolute symbol value such that user-defined elements having the same symbol name have the same value. In contrast, when different versions of the standard library L are specified to be used for a plurality of compilation target code S files, the compilation unit 22 determines the absolute symbol value for each symbol so that, even for user-defined elements having the same symbol name, the absolute symbol values differ for each version of the standard library L.

For example, the compilation unit 22 determines the absolute symbol value, for each user-defined element by calculating a hash value of the information (including version information) of the standard defined element of the standard library L used by the user-defined element. In this way, for user-defined elements having the same name, different hash values are obtained when different versions are specified at the time of compilation, and the same hash value is obtained when the same version is specified. That is, a value unique to each version of the standard defined element used by the user-defined element is determined as the absolute symbol value associated with the user-defined element.

After that, when linking the object code files, the linking unit 23 verifies whether the absolute symbol values of the user-defined elements to be linked match each other, and outputs an error when the verification results in a mismatch. Thus, when an attempt is made to link object code files using the standard defined elements defined in different versions of the same standard library L, the inconsistency can be detected in advance. Note that such verification of an absolute symbol may be achieved by a function related to the absolute symbol conventionally provided by a linker program. When a mismatch in absolute symbol values is detected, the linking unit 23 of the present embodiment may present to the user an error message indicating that the mismatch is attributed to a mismatch in the versions of the standard library L. This allows the user to easily identify the cause of the error.

The compilation unit 22 does not need to newly determine an absolute symbol value for the names of all user-defined elements appearing in the compilation target code S. Specifically, when a user-defined element that includes a standard defined element of the standard library L is newly defined, or when the user-defined element is used in a manner that references the internal structure (such as members of a structure), the compilation unit 22 determines an absolute symbol value for the user-defined element. On the other hand, at the stage where a user-defined element is simply declared (such as when a class is declared), there is no need to determine the absolute symbol value for that user-defined element. In the case of a class template, the absolute symbol value is not required at the stage where the class template is defined, and when the class template is instantiated (when an instance of the class is created), the absolute symbol value is determined for that instance.

Further, when determining whether a given user-defined element uses a standard defined element, the compilation unit 22 does not need to recursively search, for all user-defined elements used by that user-defined element, whether they internally use a standard defined element, and may instead determine the absolute symbol value for a user-defined element that directly uses a standard defined element. For example, when a function func uses a structure B that includes, as a member, a structure A which uses a standard defined element, the absolute symbol value for the structure A is determined at the stage where the structure A is defined. Further, since the structure A is used when the structure B is defined, the absolute symbol value of the structure A is determined according to the version of the standard library L. This absolute symbol value is compared with the absolute symbol value determined when the structure A is defined, and if a mismatch is found, an error is detected. Therefore, inconsistency due to a difference in the version of the standard library L can be avoided without newly determining the absolute symbol value for the structure B that does not directly use the standard defined element.

As described above, according to the information processing device 10 of the present embodiment, it is possible to easily perform compilation using different versions of the standard library L for respective compilation target code S files, and to use a plurality of versions of the standard library L from a single compilation target code S file. Further, a plurality of versions can be safely used by avoiding inconsistency caused by coexistence of the plurality of versions.

Note that the embodiment of the present disclosure is not limited to the one described above. For example, the above description deals with a case in which two versions of the standard library L are used, but is not limited thereto. The information processing device 10 of the present embodiment may adopt the above-described technique to selectively use three or more versions of the standard library L or to allow them to coexist. Further, the information processing device 10 of the present embodiment may apply the above-described technique to use a plurality of versions of any library, not limited to the standard library L, if such versions exist. Further, in the present embodiment, the compilation target code S is written in the programming language C++, but is not limited thereto. Source code written in another programming language may also be a target for compilation by the information processing device 10 of the present embodiment.

Further, in the above description, the method by which the user specifies the version of the standard library L to be used at the time of compilation, the method of describing the source code such that a plurality of versions coexist, and the like are merely examples, and various methods may be adopted to achieve the same function. For example, as a method for specifying the version of the standard library L to be used, a default specification may be set in advance using a configuration file, an environment variable, or the like, and the version specification receiving unit 21 may adopt the default specification when no other specification is accepted at the time of compilation. Further, the user may select an option for version specification in advance by using a predetermined command or the like before execution of compilation, and the version specification receiving unit 21 may accept the version specification according to the option selected in advance by the user at the time of compilation. Further, the description for switching versions in the source code may be written in a location that is regarded as a comment in the language specification.

Note that the functions achieved by the elements described in the present specification may be implemented by any circuitry or processing circuitry including a general-purpose processors, special-purpose processors, integrated circuits, application specific integrated circuits (ASICs), central processing units (CPUs), conventional circuitry, and/or a combination thereof, configured or programmed to achieve the described functions. The processor includes a transistor and other circuits, and is regarded as circuitry or processing circuitry. The processor may be a programmed processor configured to execute a program stored in memory.

In this specification, circuitry, a unit, or a means is hardware programmed to achieve the function described or hardware configured to execute the function. The hardware may be any hardware disclosed in this specification, or any hardware programmed to achieve the function described or known to execute the function. In a case where the hardware is a processor considered to be a kind of circuitry, the circuitry, means, or unit is a combination of hardware and software used to operate the hardware and/or the processor.

The present disclosure may include the following aspects.

### Item 1

An information processing device configured to compile source code written in a predetermined programming language and using a library having a plurality of versions, the information processing device including circuitry configured to:
when source code to be compiled is accepted and the source code accepted uses defined elements defined in the library,
accept a version specification specifying whether
(1) to use a defined element of any version among the plurality of versions, or
(2) to allow coexistence of defined elements of the plurality of versions; and
compile the source code accepted, by treating each of the defined elements in the source code accepted as a defined element of any version among the plurality of versions according to the version specification.

### Item 2

An information processing device configured to compile source code written in a predetermined programming language and using a library having a plurality of versions, the information processing device including circuitry configured to:
accept source code that uses defined elements defined in the library as a target for compilation; and
perform compilation by treating each of the defined elements used in the source code accepted as a defined element of a predetermined default version among the plurality of versions when the version of the defined element is not explicitly specified, and, when the version is explicitly specified, by treating each of the defined elements used in the source code accepted as a defined element of the explicitly specified version.

### Item 3

In the information processing device of Item 2,
the circuitry is configured: to accept a version specification specifying whether
(1) to use a defined element of any version among the plurality of versions, or
(2) to allow coexistence of defined elements of the plurality of versions, and, when the specification of (2) is accepted, to also accept a specification of the default version; and
when the specification of (2) is accepted, to perform compilation by treating each of the defined elements used in the source code accepted as a defined element of the specified default version when the version of the defined element is not explicitly specified, and, when the version is explicitly specified, by treating each of the defined elements used in the source code accepted as a defined element of the explicitly specified version.
   item 4

In the information processing device of any one of Items 1 to 3,
the defined elements defined in the library include at least one of a class, a function, a variable, or a type alias.
   item 5

In the information processing device of any one of Items 1 to 3,
the circuitry is configured:
when compiling source code including a user-defined element that is defined in the source code and uses a defined element defined in the library, to output, in association with a symbol representing the user-defined element, an identification value that differs depending on the version of the defined element in the library used by the user-defined element; and
when linking a plurality of objects obtained by compiling source code files different from each other, to compare the identification values that are associated with the symbols each representing the user-defined element and are included in the respective objects, and to determine whether or not linking is permitted.

### Item 6

In the Information Processing Device of Item 1,
the circuitry is configured, when a command to include a header declaring a predetermined defined element defined in the library is included in the source code, to preferentially include a representative header prepared in advance for the predetermined defined element, and, based on a description of the representative header and content of the version specification, to selectively include one or more headers to be used for compilation among a plurality of headers declaring the predetermined defined element corresponding to the respective versions.

### Item 7

In the Information Processing Device of Item 6,
the circuitry is configured, when including the one or more headers declaring the predetermined defined element corresponding to the respective versions, to control such that a macro used in each of the headers for inclusion is expanded to content corresponding to the version of each header, based on the description of the representative header.

### Item 8

An information processing method for compiling source code written in a predetermined programming language and using a library having a plurality of versions, the information processing method including:
when source code to be compiled is accepted and the source code accepted uses defined elements defined in the library,
accepting a version specification specifying whether
(1) to use a defined element of any version among the plurality of versions, or
(2) to allow coexistence of defined elements of the plurality of versions; and compiling the source code accepted, by treating each of the defined elements in the source code accepted as a defined element of any version among the plurality of versions according to the version specification.

### Item 9

A non-transitory computer-readable information storage medium storing a program that causes
an information processing device configured to compile source code written in a predetermined programming language and using a library having a plurality of versions to execute processing of:
when source code to be compiled is accepted and the source code accepted uses defined elements defined in the library,
accepting a version specification specifying whether
(1) to use a defined element of any version among the plurality of versions, or
(2) to allow coexistence of defined elements of the plurality of versions; and compiling the source code accepted, by treating each of the defined elements in the source code accepted as a defined element of any version among the plurality of versions according to the version specification.

What is claimed is:

1. A device comprising:
a memory configured to store instructions; and
a processor configured to execute the instructions that, when executed by the processor, cause the processor to:
upon acceptance of source code including elements defined in a library having a plurality of versions, accept a version specification specifying whether to:
use an element of any version among the plurality of versions; or
allow coexistence of elements of the plurality of versions; and
compile the source code by processing each of the elements in the source code as an element of any version among the plurality of versions according to the version specification.

2. The device of claim 1, wherein
the elements include at least one of a class, a function, a variable, or a type alias.

3. The device of claim 1, wherein the instructions, when executed by the processor, further cause the processor to:
output an identification value in association with a symbol representing a user-defined element based on a version of an element used by the user-defined element, upon compiling the source code that includes the user-defined element defined in the source code using the element defined in the library; and
when linking a plurality of objects obtained by compiling source code files different from each other,
compare the identification values in the respective objects that are associated with symbols representing respective user-defined elements; and
determine whether linking the plurality of objects is permitted.

4. The device of claim 1, wherein the instructions, when executed by the processor, further cause the processor to:
preferentially include a representative header for a predetermined element based on a command in the source code instructing to include a header declaring the predetermined element defined in the library; and
based on a description of the representative header and content of the version specification, selectively include one or more headers for compilation among a plurality of headers declaring the predetermined element corresponding to the respective versions.

5. The device of claim 4, wherein the instructions, when executed by the processor, further cause the processor to expand a macro used in each of one or more headers to content corresponding to a version of each header, based on description of the header, upon including the one or more headers declaring the predetermined element corresponding to the respective versions.

6. A device comprising:
a memory configured to store instructions; and
a processor configured to execute the instructions that, when executed by the processor, cause the processor to:
accept source code that uses elements defined in a library having a plurality of versions; and
when a version is specified, compile the source code by processing each of the elements in the source code accepted as an element of the version; or
otherwise, compile the source code by processing each of the elements in the source code as an element of a predetermined version among the plurality of versions.

7. The device according to claim 6, wherein the instructions, when executed by the processor, further cause the processor to:
accept a version specification specifying whether to:
use an element of any version among the plurality of versions, or
allow coexistence of elements of the plurality of versions; and
when the specification allows coexistence of the elements of the plurality of versions,
accept a specification of the predetermined version; and
compile the source code by processing each of the elements in the source code as an element of a version when the version is specified; or
otherwise, compile the source code by processing each of the elements in the source code as an element of the predetermined version.

8. The device of claim 6, wherein the elements include at least one of a class, a function, a variable, or a type alias.

9. The device of claim 6, wherein the instructions, when executed by the processor, further cause the processor to:
output an identification value in association with a symbol representing a user-defined element based on a version of an element used by the user-defined element, upon compiling the source code that includes the user-defined element defined in the source code using the element defined in the library; and
when linking a plurality of objects obtained by compiling source code files different from each other,
compare the identification values in the respective objects that are associated with symbols representing respective user-defined elements; and
determine whether linking the plurality of objects is permitted.

10. The device of claim 7, wherein the instructions, when executed by the processor, further cause the processor to:
preferentially include a representative header for a predetermined element based on a command in the source code instructing to include a header declaring the predetermined element defined in the library; and
based on a description of the representative header and content of the version specification, selectively include one or more headers for compilation among a plurality of headers declaring the predetermined element corresponding to the respective versions.

11. The device of claim 10, wherein the instructions, when executed by the processor, further cause the processor to, upon including the one or more headers declaring the predetermined element corresponding to the respective versions, expand a macro used in each of the one or more headers to content corresponding to a version of each header, based on the description of the representative header.

12. A method comprising:
upon acceptance of source code including elements defined in a library having a plurality of versions, accepting a version specification specifying whether to:
using an element of any version among the plurality of versions; or
allowing coexistence of elements of the plurality of versions; and
compiling the source code by processing each of the elements in the source code accepted as an element of any version among the plurality of versions according to the version specification.

13. The method of claim 12, wherein
the elements include at least one of a class, a function, a variable, or a type alias.

14. The method of claim 12, further comprising:
outputting an identification value in association with a symbol representing a user-defined element based on a version of an element used by the user-defined element, upon compiling the source code that includes the user-defined element defined in the source code using the element defined in the library; and
when linking a plurality of objects obtained by compiling source code files different from each other,
comparing the identification values in the respective objects that are associated with symbols representing respective user-defined elements; and
determining whether linking the plurality of objects is permitted.

15. The method of claim 12, further comprising:
preferentially including a representative header for a predetermined element based on a command in the source code instructing to include a header declaring the predetermined element defined in the library; and
based on a description of the representative header and content of the version specification, selectively including one or more headers for compilation among a plurality of headers declaring the predetermined element corresponding to the respective versions.

16. The method of claim 15, further comprising expanding a macro used in each of one or more headers to content corresponding to a version of each header, based on description of the header, upon including the one or more headers declaring the predetermined element corresponding to the respective versions.

17. A non-transitory computer-readable medium storing instructions that, when executed by a device, causes the device to perform operations comprising:
upon acceptance of source code including elements defined in a library having a plurality of versions, accept a version specification specifying whether to:
use an element of any version among the plurality of versions; or
allow coexistence of elements of the plurality of versions; and
compile the source code by processing each of the elements in the source code accepted as an element of any version among the plurality of versions according to the version specification.

18. The non-transitory computer-readable medium of claim 17, wherein the instructions, when executed by a device, causes the device to perform the operations further comprising:
outputting an identification value in association with a symbol representing a user-defined element based on a version of an element used by the user-defined element, upon compiling the source code that includes the user-defined element defined in the source code using the element defined in the library; and
when linking a plurality of objects obtained by compiling source code files different from each other,
comparing the identification values in the respective objects that are associated with symbols representing respective user-defined elements; and
determining whether linking the plurality of objects is permitted.

19. The non-transitory computer-readable medium of claim 17, wherein the instructions, when executed by a device, causes the device to perform the operations further comprising:
preferentially including a representative header for a predetermined element based on a command in the source code instructing to include a header declaring the predetermined element defined in the library; and
based on a description of the representative header and content of the version specification, selectively including one or more headers for compilation among a plurality of headers declaring the predetermined element corresponding to the respective versions.

20. The non-transitory computer-readable medium of claim 19, wherein the instructions, when executed by a device, causes the device to perform the operations further comprising, further comprising expanding a macro used in each of one or more headers to content corresponding to a version of each header, based on description of the header, upon including the one or more headers declaring the predetermined element corresponding to the respective versions.
